(19) United States
(12) Patent Application Publication
(10) Pub. No.: US 2008/0246279 A1
(43) Pub. Date: Oct. 9, 2008

(54) Pipe Clip With Rapid Closure

(75) Inventor: Jan van Walraven, Mijdrecht (NL)

Correspondence Address: TROUTMAN SANDERS LLP, 600 PEACHTREE STREET , NE, ATLANTA, GA, 30308, US

(73) Assignee: J. van Walraven Holding B.V., Mijdrecht (NL)

(21) Appl. No.: 12/062,887

(22) Filed: Apr. 4, 2008

(30) Foreign Application Priority Data
Apr. 6, 2007 (NL) 1033654

(51) Int. Cl. F16L 3/08

(52) U.S. Cl. 285/420

(57) ABSTRACT

A pipe clip for fastening a pipe to a wall, ceiling or other support, including a clip body having an opening for fitting the pipe clip around the pipe, which opening is delimited by a first and a second end of the clip body. The pipe clip further includes a tightening element, which is connected to the first end of the clip body or acts upon the first end of the clip body and has a shank. The pipe clip further includes a female fastening element, which is fitted on the second end of the clip body and into which the shank of the tightening element pokes. The female fastening element includes a base plate having a pass-through opening for the shank, as well as at least one clamping plate, which extends at a distance from the base plate and which is provided with a pass-through opening for the shank. The clamping plate is connected to the base plate by means of a resilient hinged part. In an unloaded state, the pass-through openings in the base plate and the clamping plate partially overlap each other. The clamping plate is movable counter to the spring force in order to bring the pass-through openings into line with each other such that the shank can pass through them.

### CROSS REFERENCE TO RELATED APPLICATION

This application is based on, and claims the benefit of priority to, Netherlands application 1033654, filed 6 Apr. 2007, which priority application is hereby incorporated by reference.

### BACKGROUND OF THE INVENTION

1. Field of Invention

The present invention relates to a pipe clip

2. Description of Related Art

From EP 1 022 502 a pipe clip having a spring nut is known, wherein the tightening screw is inserted into a spring nut supported on a flange on the second end of the clip body, whilst the head of the tightening screw can engage behind lips of a flange on the first clip end. The spring nut is formed from spring steel and is substantially annular. On one side, the spring nut is split and on each of the ends which come together there half of a screw thread collar is fitted. The screw thread collar has a plurality of windings of an internal screw thread, through which the shank of the tightening screw can be forced. On each half of the screw thread collar, an operating lip is fitted, which extends outwards from the screw thread collar. This known spring nut is shaped such that, in the tightening operation, pressure is applied with a finger to the tightening element, whilst at the same time two other fingers press on the operating lips, so that the halves of the screw thread collar are spread apart and the tightening element can pass alongside them. The compressive force which is required upon the tightening screw is limited thereby.

The object of the invention is to provide a pipe clip having an alternative tightening construction.

This object is achieved according to the invention by a pipe clip according to claim 1.

### BRIEF SUMMARY OF THE INVENTION

In the pipe clip according to the invention, the pass-through openings in the base plate and in the clamping plate are brought into line by moving the clamping plate and by feeding the shank of the tightening element through the pass-through openings. By then releasing the clamping plate, this is moved back by the spring force of the resilient hinged part until the rim of the pass-through opening acts upon the shank of the tightening element. The shank is then clamped between the rims of the pass-through openings. In order to release the tightening element, the pass-through openings in the base plate and in the clamping plate are brought into line by moving the clamping plate and then withdrawing the shank.

Preferably, the female fastening element comprises two parallel clamping plates, which are each connected to the base plate by means of a resilient hinged part and are movable in opposite direction counter to the spring force of the respective resilient hinged parts. In this preferred embodiment, the pass-through openings in the base plate and in the clamping plates are brought into line by displacing the clamping plates in the opposite direction parallel to each other and feeding the shank of the tightening element through the pass-through openings. By then releasing the clamping plates, these are each moved back by the spring force of the associated resilient hinged part, until the rim of the particular pass-through opening acts upon the shank of the tightening element. The shank is then clamped at least between the rims of the pass-through openings in the clamping plates. This embodiment has the advantage that the shank of the tightening element is loaded from two sides in the transverse direction by substantially the same spring force, whereby the resultant transverse load upon the shank is approximately nil and the shank is not pulled out of alignment.

In a further preferred embodiment, the pass-through opening in the clamping plate is substantially drip-shaped, the narrower part of the drip shape preferably being directed away from the direction of the spring force. In this embodiment, the tapering part of the pass-through opening is drawn against the shank of the tightening element by the spring force of the hinged part accompanying the particular clamping plate, whereby a better clamping effect is procured. This drip shape is also advantageous when the tightening element is removed again.

According to the invention, an embodiment is provided, wherein the pass-through opening in the clamping plate is shaped such that, when the shank of the tightening element is inserted, the axial force upon the tightening element is already sufficient to cause displacement of the clamping plate(s), so that the shank can pass through. In order to be able to withdraw the shank when the pipe clip is released, the clamping plates must be moved by a fitter counter to the spring force, so that the pass-through openings are aligned such that the shank can comfortably pass through.

### BRIEF DESCRIPTION OF THE DRAWINGS

The invention will be described in greater detail in the following description with reference to the drawing, wherein:

FIG. 1 shows a perspective view of an embodiment of a pipe clip according to the invention in an open state.

FIG. 2 shows a perspective view of the pipe clip of FIG. 1 in a closed state.

FIG. 3 shows a perspective view of the pipe clip of FIG. 1 as it is released.

FIG. 4 shows a perspective view of a female fastening element associated with the pipe clip of FIG. 1.

FIG. 5 shows a top view of the female fastening element of FIG. 4.

FIG. 6 shows a side view of the female fastening element of FIG. 4.

FIG. 7 shows a bottom view of the female fastening element of FIG. 4.

FIG. 8 shows a top view of the female fastening element of FIG. 4 in an unfolded state.

FIG. 9 shows a side view of a tightening element of the pipe clip of FIG. 1.

FIGS. 10a and 10b show two possible alternative tightening elements.

FIG. 11 shows a top view of an alternative embodiment of a female fastening element.

FIG. 12 shows a side view of the female fastening element of FIG. 11.

### DETAILED DESCRIPTION OF PREFERRED EMBODIMENTS

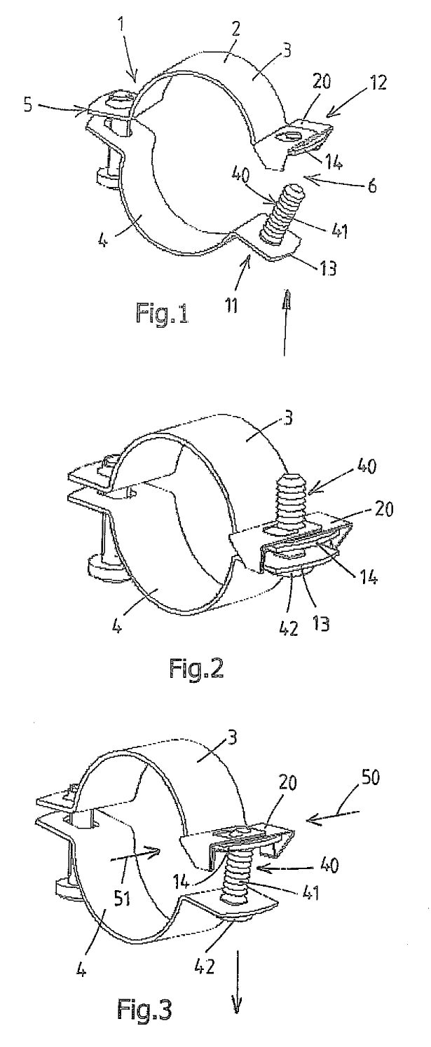

In FIGS. 1-3 a pipe clip 1 is shown, having a clip body 2 comprising two clip halves 3 and 4, which are articulately connected to each other by means of hinge means 5. The clip body 2 has a first end 11 and a second end 12, which delimit an opening 6 for the fitting of the pipe clip 1 around a pipe (not shown). The opening 6 can be enlarged or reduced by articulating the clip halves 3 and 4 away from each other or articulating them towards each other. At the first end 11, a first flange 13 is formed on, and at the second end 12 a second flange 14 is formed on. The first flange 13 and the second flange 14 are provided with an opening for the introduction of a tightening element 40 provided with a shank 41 and a head 42.

In the mounting operation, the shank 41 of the tightening element 40 is fed from the side of the first flange 13 which is facing away from the second flange 14 through the opening in the first flange 13 and then through the opening in the second flange 14. The head 42 of the tightening element 40 is thus located on the side of the first flange 13 which is facing away from the second flange 14. To the second end 12 of the clip body 2 there is fitted a female fastening element 20, through which the shank 41 of the tightening element 40 can be fed in order to secure this and keep the clip 1 closed.

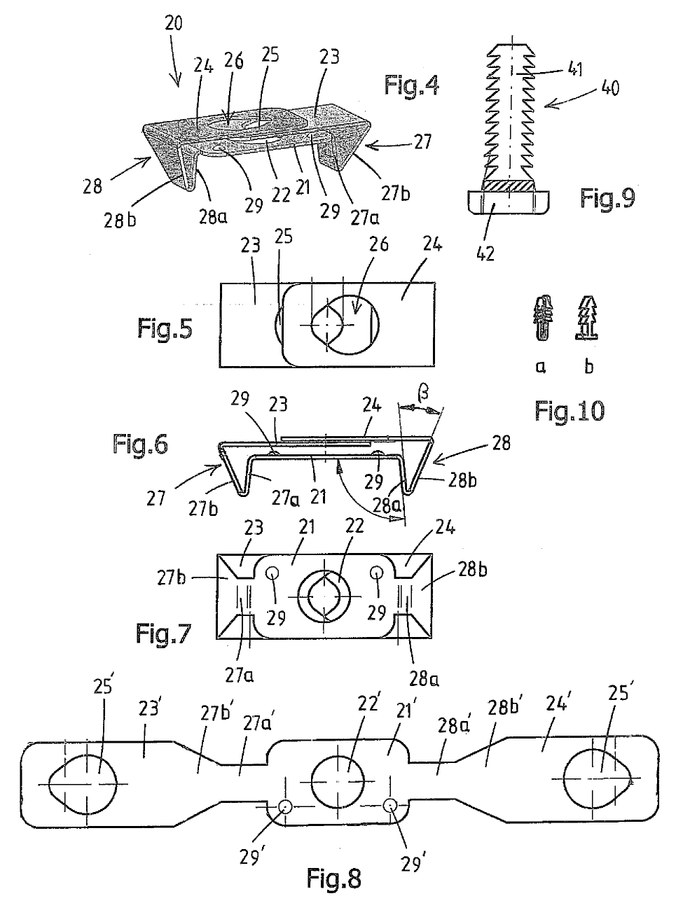

The female fastening element 20 is shown in greater detail in FIGS. 4-7. The female fastening element 20 comprises a base plate 21 having a pass-through opening 22 for the shank 41. The fastening element 20 further comprises two clamping plates 23 and 24 extending parallel to each other and parallel to the base plate. The clamping plates 23 and 24 partially overlap each other in a region above the pass-through opening 22 in the base plate 21 and in the overlap region preferably bear one against the other.

In the clamping plate 23, a pass-through opening 25 for the shank 41 is provided, in the other clamping plate 24 a pass-through opening 26 for the shank 41 is provided. In the embodiment shown, the pass-through openings 25 and 26 are substantially drip-shaped. A different suitable shape is also conceivable. In an unloaded state, the pass-through openings 25 and 26 partially overlap each other, as can best be seen in FIG. 5.

The clamping plates 23 and 24 are connected to the base plate 21 by means of a resilient hinged part 27 and 28. In the embodiment shown in FIGS. 4-7, the hinged part 27 or 28 comprises a first leg 27a or 28a, which is connected to the base element 21, and a second leg 27b or 28b, which is connected to the clamping plates 23 and 24. The base plate is preferably somewhat wider than the flange 14, the first leg 27a or 28a preferably standing at an angle α (see FIG. 6) of 90°-100° relative to the base plate. In the specific embodiment shown in the figures, the angle α between the legs measures approximately 95° relative to the base plate 21. Although this is not preferable at this moment, if the width of the base plate 21 sufficiently exceeds the width of the flange 14, there is also the possibility of choosing the angle α less than 90°, for example 80°. The first leg 27a or 28a and the second leg 27b or 28b enclose an angle β (see FIG. 6), which in the specific embodiment shown is acute and measures approximately 27°. The angles α and β can also be other than shown in the specific illustrative embodiment, without deviating from the inventive concept. All that is important is that a suitable resilient effect is obtained to bring the pass-through openings 22, 25, 26 into mutual alignment, so that the shank 41 of the tightening element 40 can pass through them.

Moreover, this resilient effect of the hinged part can also be achieved in many other ways instead of that construction of the resilient hinged part, having mutually angled legs, which is specifically shown here, and these other conceivable embodiments are also deemed to fall within the scope of the invention.

The female fastening element 20 is preferably made of metal from one piece. Preferably, the fastening element 20 is made of spring steel by punching or cutting and bending. In FIG. 8, the female fastening element 20 is shown in the unfolded state, the component parts being indicated with the same reference numerals as in the description above, provided with an accent sign. From this figure, it can be seen that the second leg 27b′, 28b′ tapers from the clamping plate 23′, 24′ in the direction of the first leg 27a′, 28a′.

It is also conceivable for the female fastening element to be made of a different metal, of plastic, or of a combination of metal and plastic.

As has already been stated above, the female fastening element is fitted to the flange 14 on the second end 12 of the pipe clip body 2. The flange 14 has a pass-through opening for the shank 41 of the tightening element 40. The base plate 21 of the female fastening element 20 is fitted to the side of the flange 14 facing towards the first end 11 of the clip body 2 and bears against this side of the flange 14. The clamping plates 23, 24 are fitted to the other side of the flange 14. An embodiment is also conceivable, moreover, in which the base plate 21 of the female fastening element 20 is fitted to the side of the flange 14 facing away from the first end 11 of the clip body 2, and the clamping plates 23, 24 are fitted to the side of the flange 14 facing towards the first end 11. The resilient hinged parts 27 and 28, which connect the base plate 21 to the respective clamping plates 23, 24, extend along the mutually opposing side edges of the flange 14. The distance between the clamping plate 23 situated closest to the flange 14 and the base plate 21 approximately conforms to the thickness of the flange 14. In order to prevent the fastening element 20 from possibly being pushed off the flange 14, the base plate 21 is provided with one or more, in the illustrated example two bulges 29, and the flange 14 is provided with one or more, in the illustrated example two, preferably complementary recesses, for example indentations or holes in which the bulges are received.

In an unloaded state, the pass-through openings 22, 25 and 26 in the base plate 21 and the clamping plates 23 and 24 partially overlap one another, as can best be seen in FIG. 5 and FIG. 7. By pressing of the legs 27b and 28b inwards counter to the spring force of the resilient hinged parts 27, 28, as is illustrated in FIG. 3 with the arrows 50 and 51, the clamping plates 23 and 24 are displaced relative to each other and relative to the base plate 21, whereby the pass-through openings 22, 25 and 26 can be brought into mutual alignment such that a free passage is procured for the shank 41, which can pass through them. In this way, the tightening element 40 can be forced into the female fastening element 20 or pulled out of it without any significant resistance.

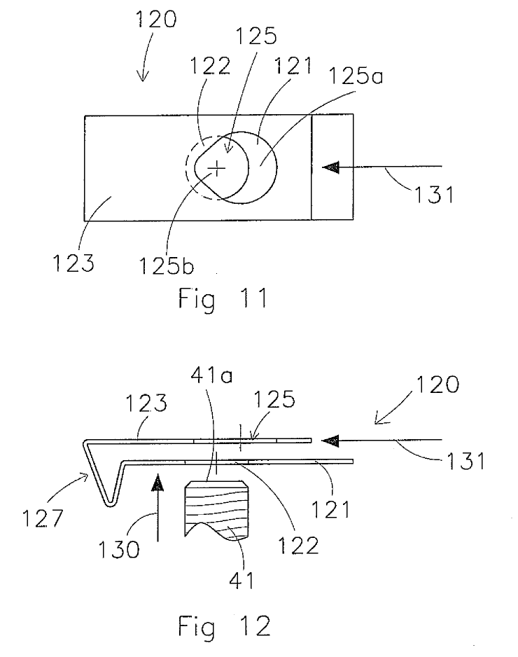

An embodiment is conceivable in which the spring force of the hinged parts is chosen such that the shank 41 can be forced through the openings without displacing the clamping plate relative to the base plate. In order to remove the tightening element 40, the clamping plates must then be displaced in order to bring the pass-through openings in the base plate and the clamping plate into line such that the shank can be withdrawn. An embodiment of this type is shown in FIG. 11 and FIG. 12.

FIG. 11 and FIG. 12 show in a top view and a side view, respectively, a female fastening element 120. The female fastening element 120 comprises a base plate 121 containing a pass-through opening 122. At a distance from the base plate 121, a clamping plate 123 extends substantially parallel to the base plate 121. The clamping plate 123 is provided with pass-through opening 125 having substantially a drip shape. The drip-shaped pass-through opening 125 has a wider portion 125a and a narrower portion 125b. The base plate 121 and the clamping plate 123 are connected to each other by means of a resilient hinged part 127. The resilient hinged part 127 is comparable with the resilient hinged part 27 described with reference to FIGS. 4-8. In theory, a differently realized resilient connection between the clamping plate and the base plate would also be possible. The narrower part 125b of the pass-through opening 125 in the clamping plate 123 is facing in the direction of the spring force. In the unloaded state, the pass-through opening 122 in the base plate 121 and the wider part 125a of the pass-through opening 125 in the clamping plate 123 are not mutually aligned.

In use, a shank 41 of a tightening element 40 can be fed through the pass-through opening 122 of the base plate 121, as is illustrated with the arrow 130 in FIG. 12. Next, the end face 41a of the shank 41 will butt against the region around the narrower portion 125b of the drip-shaped pass-through opening 125 in the clamping plate 123, whereby the clamping plate 123 will be forced upwards and will bend and/or swivel around the hinged part 127. The wider portion 125a of the drip-shaped pass-through opening 125 thereby comes into line with the pass-through opening 122 in the base plate 121 and the shank 41 can pass through the two pass-through openings 122 and 125. By maintaining a sufficiently small distance between the base plate 121 and the clamping plate 123, the clamping plate 123 cannot deflect far enough the other way to allow the shank to be withdrawn from the clamping plate 123. In order to be able to withdraw the shank 41, the fitter can press the clamping plate 123 in the direction of the resilient hinged part 127 counter to the spring force, as is illustrated with the arrow 131 in FIG. 11 and FIG. 12. The pass-through opening 122 in the base plate 121 and the wider portion 125a of the pass-through opening 125 in the clamping plate 123 are thereby brought into line and the shank 41 is able to be withdrawn without any significant hindrance.

For the tightening element, a number of embodiments are conceivable. In FIG. 9, a preferred embodiment is shown, in which the tightening element 40 has a shank 41 and a head 42. The shank 41 is provided with a toothing or serrations, which can hook behind the rim of the pass-through openings 25, 26. In the illustrated preferred embodiment, the teeth have an angle of 45°. As a result of this shape, the shank 41 can be forced more easily through the pass-through openings 25, 26 in the mounting operation and yet a secure connection is ensured. As the tightening element, a screw could also be used. Other pin-shaped elements having a head and a shank, preferably provided with serrations or barbs, are also conceivable. In FIG. 10, two examples of such tightening elements are shown, in FIG. 10a a variant being shown having two sets articulately connected to each other and provided with barbs. In FIG. 10b, a variant is shown having a barbed shank of right-angled cross-section. It is noted that the term shank does not have to be interpreted restrictively and is not necessarily required to have a round cross section. It can have any suitable shape and, in the case of a part formed integrally onto the clip body, for example, would be a strip-shaped or lip-shaped member.

Instead of a loose tightening element as shown in the figures, it is also conceivable for a tightening element having a shank to be formed integrally onto the first end of the clip body. A tightening element can also be fixedly fitted to the first end of the clip body, for example by welding.

I claim:

1. Pipe clip for fastening a pipe to a wall, ceiling or other support, comprising:
a clip body having an opening for fitting the pipe clip around the pipe, which opening is delimited by a first and a second end of the clip body;
a tightening element, which is connected to the first end of the clip engages on the first end of the clip body and comprises a shank; and
a female fastening element, which is fitted on the second end of the clip body and into which the shank of the tightening element is inserted;
wherein the female fastening element comprises a base plate having a pass-through opening for the shank, as well as at least one clamping plate, which extends at a distance from the base plate and which is provided with a pass-through opening for the shank, which clamping plate is connected to the base plate by means of a resilient hinged part, in an unloaded state the pass-through openings in the base plate and the clamping plate partially overlapping each other and the clamping plate being movable counter to the spring force in order to bring the pass-through openings into line with each other such that the shank can pass through them.

2. Pipe clip according to claim 1, wherein the base plate and the clamping plate extend substantially parallel to each other.

3. Pipe clip according to claim 2, wherein the clamping plate is movable substantially parallel to the base plate.

4. Pipe clip according to claim 1, wherein the female fastening element comprises two parallel clamping plates, which are each connected to the base plate by means of a resilient hinged part and are movable in opposite direction counter to the spring force of the respective resilient hinged parts.

5. Pipe clip according to claim 1, wherein the pass-through opening in the clamping plate has a wide portion and a narrower portion, the shank being able to pass through the wider portion of the pass-through opening.

6. Pipe clip according to claim 5, wherein the narrower part of the pass-through opening is directed away from the direction of the spring force.

7. Pipe clip according to claim 5, wherein the narrower part of the pass-through opening is directed in the direction of the spring force.

8. Pipe clip according to claim 5, wherein the pass-through opening is substantially drip-shaped.

9. Pipe clip according to claim 1, wherein the resilient hinged part comprises two mutually connected legs extending at an angle, one leg being connected to the base plate and the other leg to the clamping plate.

10. Pipe clip according to claim 9, wherein the leg which is connected to the base plate extends in a transverse direction relative to the base plate.

11. Pipe clip according to claim 10, wherein the leg which is connected to the base plate extends at an angle of at least approximately 80° relative to the base plate.

12. Pipe clip according to claim 10, wherein the leg which is connected to the base plate extends at an angle of between approximately 90° and approximately 135°.

13. Pipe clip according to claim 9, wherein the legs of the hinged part enclose an acute angle.

14. Pipe clip according to claim 1, wherein the base plate, the resilient hinged part and the clamping plate of the female fastening part are made in one piece.

15. Pipe clip according to claim 14, wherein the female fastening element is made of metal.

16. Pipe clip according to claim 14, wherein the female fastening element is made of plastic.

17. Pipe clip according to claim 14, wherein the female fastening element is made of a combination of metal and plastic.

18. Pipe clip according to claim 1, wherein the base plate of the female fastening element is connected to the end of the pipe clip body.

19. Pipe clip according to claim 1, wherein a flange is provided at the second end of the clip body, to which flange the female fastening element is fitted.

20. Pipe clip according to claim 19, wherein the base plate of the female fastening element is located on the side of the flange which is facing towards the first end of the clip body.

21. Pipe clip according to claim 19, wherein the clamping plate is located on the side of the flange which is facing away from the first end of the clip body.

22. Pipe clip according to claim 20, wherein the base plate of the female fastening element bears against the flange.

23. Pipe clip according to claim 22, wherein the distance between the clamping plate situated closest to the flange and the base plate approximately conforms to the thickness of the flange.

24. Pipe clip according to claim 22, wherein the flange or the base plate is provided with one or more recesses, and the base plate or the flange is provided with one or more bulges, which are accommodated in the recesses.

25. Pipe clip according to claim 1, wherein the shank of the tightening element is provided with an external screw thread, serrations, toothings, or barbs.

26. Pipe clip according to claim 1, wherein the tightening element has a head and a shank, wherein the head engages on the first end of the clip body.

27. Pipe clip according to claim 1, wherein the tightening element is fixedly connected to the first end of the clip body.
